(19) United States
(12) Patent Application Publication
(10) Pub. No.: US 2008/0122999 A1
(43) Pub. Date: May 29, 2008

(54) LIQUID CRYSTAL DEVICE, PROJECTOR, AND ELECTRONIC APPARATUS

(75) Inventors: Yutaka TSUCHIYA, Nagano-ken (JP); Kosuke UCHIDA, Saitama-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/855,620

(22) Filed: Sep. 14, 2007

(30) Foreign Application Priority Data
Sep. 29, 2006 (JP) 2006-269918

(51) Int. Cl. G02F 1/13; G02F 1/1343

(52) U.S. Cl. 349/33; 349/143

(57) ABSTRACT

A liquid crystal device has a pair of substrates arranged so as to face each other and a liquid crystal layer interposed between the pair of substrates and performs a display operation or an optical modulation operation by converting an alignment of liquid crystal molecules in the liquid crystal layer from a splay alignment to a bend alignment. The liquid crystal device includes a plurality of pixel electrodes disposed on either one of the pair of substrates so as to correspond to a plurality of pixels, and an auxiliary electrode formed in a layer disposed under the pixel electrodes in a manner such that at least part thereof overlaps the pixels in a plan view and made of a light-transmissible conductive material.

### BACKGROUND

1. Technical Field

The present invention relates to a liquid crystal device, a projector, and an electronic apparatus.

2. Related Art

In the field of a liquid crystal device for use in liquid crystal displays and projectors, there is a demand for picture quality improvement for moving images as well as still pictures. To obtain moving images with high quality, it is essential to improve the response time of a liquid crystal device. In recent years, optical compensated bend (OCB) mode liquid crystal devices have been attracting attention.

In an OCB mode liquid crystal device, an alignment of liquid crystal molecules changes according to operation states, an initial state and a display state. In the initial state, liquid crystal molecules are controlled between two substrates such that the liquid crystal molecules are aligned in a splay form (splay alignment). However, in the display state, the liquid crystal molecules are controlled between two substrates such that the liquid crystal molecules are aligned in a curve form like an arc (bend alignment).

To perform a display operation and an optical modulation operation in the OCB mode liquid crystal device, a driving voltage must be applied to the OCB mode liquid crystal device which is initially set in the bend alignment. In the case in which the OCB mode liquid crystal device is in the bend alignment, transition from one alignment state to another alignment state of liquid crystal molecules relatively quickly occurs in comparison with a twisted nematic (TN) mode and a super twisted nematic (STM) mode. Accordingly, light transmittance of a liquid crystal layer can vary in a short time and thus fast response speed can be obtained.

In the OCB mode liquid crystal device, a voltage not lower than a threshold voltage must be applied to a liquid crystal layer (LC layer, in order to convert the alignment of liquid crystal molecules from the splay alignment to the bend alignment (initial transition manipulation). If the initial transition manipulation is insufficient, transition from the splay alignment to the bend alignment is incompletely carried out, thereby resulting in defective display or slow response speed. JP-A-2003-84299 discloses a technique to facilitate splay-to-bend transition, in which the initial transition from the splay alignment to the bend alignment is performed by arranging a dedicated control electrode under a pixel electrode and generating a strong electric field between the control electrode and the pixel electrode (or a common electrode). By this technique, a nucleus for a bend alignment can be easily created, and thus splay-to-bend alignment transition is promptly and stably performed.

However, the technique disclosed in JP-A-2003-84299 has a problem in that light is blocked in a pixel in the case in which the control electrode overlaps the pixel electrode in a plan view because the control electrode is made of a metal, such as aluminum. For this reason, installation of the control electrode is limited to a predetermined position. Accordingly, even though a strong electric field is generated between the pixel electrode (common electrode) and the control electrode, the strong electric field cannot fully contribute to the increase in efficiency of creation of bend nuclei and the decrease in the splay-to-bend transition time.

### SUMMARY

An advantage of some aspects of the invention is to provide a liquid crystal device which is capable of effectively performing a fast bend transition, a projector and an electronic apparatus incorporating the same.

According to an aspect of the invention, there is provided a liquid crystal device including a pair of substrate opposing each other and a liquid crystal layer interposed between the pair of substrates and performing a display operation or an optical modulation operation by converting an alignment of liquid crystal molecules in the liquid crystal layer from a splay alignment to a bend alignment, in which the liquid crystal device further includes pixel electrodes disposed on either of the pair of substrates so as to correspond to pixels, and an auxiliary electrode formed in a layer disposed under the pixel electrodes in a way of having at least part overlapping the pixels in a plan view and made of a light-transmissible material.

According to the above aspect, the auxiliary electrode is provided in a layer disposed under pixel electrodes and made of a light-transmissible material in a manner of having at least part overlapping pixels in a plan view. Accordingly, even the structure in which the auxiliary electrode overlaps the pixels in a plan view does not block light. Moreover, since the auxiliary electrode overlaps the pixels in a plan view, it is possible to generate a strong electric field, which contributes to improvement in efficiency of creation of bend nuclei. As a result, it is possible to effectively perform fast bend transition.

In the liquid crystal device, it is preferable that the auxiliary electrode is disposed over almost the entire surface of the substrate on which the pixel electrodes are disposed.

According to the above structure, since the auxiliary electrode covers almost the entire surface of the substrate of the pair of substrates, on which the pixel electrodes are disposed, a strong electric field can be generated over almost the entire area of the substrate in a plan view. Such a structure enhances efficiency of creation of bend nuclei and greatly contributes to fast bend transition.

In the liquid crystal device, it is preferable that the pixel electrodes are arranged in a first region of the substrate in the form of a matrix, switching elements allowing or not allowing driving signals to transmit are arranged in the first region and a second region disposed outside the first region in the matrix, and the auxiliary electrode is connected to some switching elements of the switching elements, which are disposed along any one line of data lines and scan lines.

According to the above structure, the pixel electrodes are arranged in the first region of the substrate in the form of a matrix. Generally, a liquid crystal device is driven by the data lines or the scan lines, one line by one line, in turns in a predetermined direction. In the case in which the switching elements connected to the auxiliary electrode are arranged in the predetermined direction, a strong electric field is generated whenever writing operations are performed. Accordingly, it is possible to enhance efficiency of creation of bend nuclei, and easily maintain the bend alignment during a display operation. Further, in the case in which the switching element connected to the auxiliary electrode are arranged in a direction perpendicular to the predetermined direction, the strong electric field is generated only during a period in which a single writing operation of the writing operations is performed. Accordingly, it is inhibited that the strong electric field maintaining the bend alignment at the time of driving the liquid crystal device influences the display and optical modulation operations of the liquid crystal device, so that excellent quality of a display can be obtained.

In the liquid crystal device, it is preferable that the auxiliary electrode is disposed in a manner such that a direction of an electric field generated between the auxiliary electrode and the pixel electrodes intersects an alignment direction of liquid crystal molecules arranged in the splay alignment.

In the above structure, since the auxiliary electrode is disposed in a manner such that an electric field generated between the auxiliary electrode and the pixel electrode directs so as to intersect an alignment direction of liquid crystal molecules arranged in the splay alignment, it is possible to twist the liquid crystal molecules in a direction that the strong electric field generated between the auxiliary electrode and the pixel electrode exerts. The twisted liquid crystal molecules can promote creation of bend nuclei and thus the bend transition can be quickly completed.

In the liquid crystal device, it is preferable that a number of the pixel electrodes is plural, a number of wirings which supplies electric signals to the plural pixel electrodes is plural, one wiring by one wiring of the wirings supplies a signal to the corresponding pixel electrodes, and the auxiliary electrode includes first auxiliary electrodes which cooperate with the pixel electrodes to generate a first electric field and second auxiliary electrodes which cooperate with the pixel electrodes electrically insulated from the first auxiliary electrode to generate a second electric field different from the first electric field, the first auxiliary electrodes and the second auxiliary electrodes being alternately arranged along the corresponding wirings.

For example, at the time of driving the pixel electrode, a line potential inversion operation is performed in a mariner such that polarities of line potentials are alternately the same. According to the above structure, the auxiliary electrode includes a first auxiliary electrode which cooperates with some pixel electrodes of the pixel electrodes to generate a first electric field and a second auxiliary electrode which cooperates with some pixel electrodes of the pixel electrodes, which are electrically isolated from the first auxiliary electrode, to generate a second electric field different from the first electric field, and elongate portions of the first auxiliary electrode and elongate portions of the second auxiliary electrode are alternately arranged along the wirings. Accordingly, the different electric fields can be generated between the pixel electrodes and the two different kinds of auxiliary electrodes and it is possible to drive the liquid crystal device in a manner such that the strong electric field generated between the pixel electrodes and the auxiliary electrodes and the driving voltage have the same potential polarity. Thus, it is possible to inhibit disturbance in alignment of liquid crystal molecules, attributable to the driving voltages. Moreover, the liquid crystal device can be driven so as to maximize intensity of the electric field generated between the pixel electrodes and the auxiliary electrodes, so that creation of bend nuclei is promoted. Accordingly, it is possible to easily create bend nuclei, resulting in fast bend transition.

In the liquid crystal device, it is preferable that the pixel electrodes are arranged in a plurality of columns including first columns in which the auxiliary electrode overlaps the pixels in a plan view and second columns in which dummy electrodes are provided, in which the first columns and the second columns are alternately arranged.

According to the above structure, the pixel electrodes are arranged in a plurality of columns including first columns in which the auxiliary electrode overlaps the pixels in a plan view and second columns in which dummy electrodes are provided, in which the first columns and the second columns are alternately arranged. Accordingly, the dummy electrodes and the auxiliary electrode having different functions can be separately provided.

In the liquid crystal device, it is preferable that the liquid crystal device includes dummy electrodes formed in the same layer as the pixel electrodes and arranged so as to have at least part overlapping the auxiliary electrode in a plan view.

According to the above structure, the dummy electrodes are formed in the same layer as the pixel electrodes in a manner of overlapping at least part of the auxiliary electrode in a plan view. That is, the auxiliary electrode is formed in an under layer of the dummy electrodes, and the dismay electrodes and the auxiliary electrode are arranged in three dimensions. Thanks to this structure, the dummy electrodes and the auxiliary electrode having different functions can be separated provided.

According to another aspect of the invention, there is provided a projector having the above-mentioned liquid crystal device.

In this aspect, since the projector includes the liquid crystal device which is capable of effectively performing fast bend transition, the projector can perform an optical modulation operation at an improved response speed and has excellent display characteristics.

According to further aspect of the invention, there is provided an electronic apparatus having the liquid crystal device.

In this aspect, since the electronic apparatus includes the liquid crystal device which is capable of effectively performing fast bend transition, a display portion thereof operates at fast response speed and can perform a display operation with excellent display characteristics.

### BRIEF DESCRIPTION OF THE DRAWINGS

The invention will be described with reference to the accompanying drawings, wherein like numbers reference like elements.

FIGS. 1A and 1B are a plan view and a sectional view, respectively illustrating an overall structure of a liquid crystal device according to a first embodiment of the invention.

FIG. 2 is a circuit diagram illustrating an overall structure of the liquid crystal device according to the first embodiment.

FIGS. 3A, 3B, and 3C are views illustrating part of the liquid crystal device according to the first embodiment.

FIGS. 4A and 4B are explanatory views illustrating operation of an OCB mode liquid crystal device.

FIGS. 5A and 5B are explanatory views illustrating operation of a liquid crystal device.

FIG. 6 is a plan view illustrating part of a liquid crystal device according to a second embodiment of the invention.

FIG. 7 is a plan view illustrating part of a liquid crystal device according to a third embodiment of the invention.

FIG. 8 is a plan view illustrating part of a liquid crystal device according to a fourth embodiment of the invention.

FIG. 9 is a plan view illustrating part of a liquid crystal device according to a fifth embodiment of the invention.

FIGS. 10A to 10D are sectional views illustrating parts of the liquid crystal device according to the fifth embodiment.

FIG. 11 is a plan view illustrating part of a liquid crystal device according to a sixth embodiment of the invention.

FIGS. 12A to 12D are sectional views illustrating part of the liquid crystal device according to the sixth embodiment.

FIG. 13 is a schematic view illustrating an overall structure of a projector according to a seventh embodiment of the invention.

FIG. 14 is a perspective view illustrating a mobile phone according to an eighth embodiment of invention.

FIGS. 15A to 15C are plan views illustrating modifications of the liquid crystal device according to the invention.

FIG. 16 is a plan view illustrating further modification of the liquid crystal device according to the invention.

### DESCRIPTION OF EXEMPLARY EMBODIMENTS

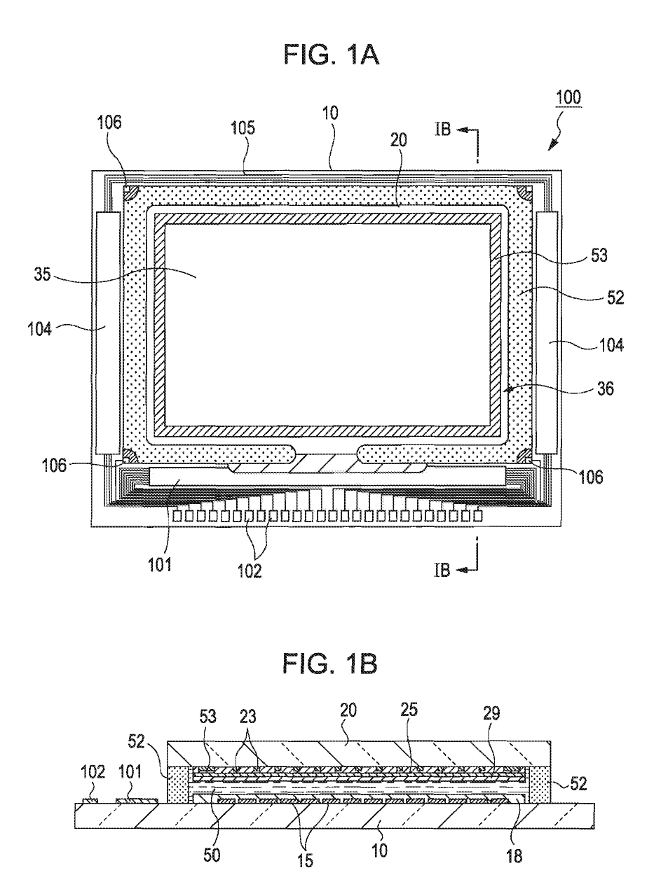

FIG. 1A is a plan view showing elements of a liquid crystal device, which is viewed from a counter substrate. FIG. 1B is a sectional view taken along line H-H in FIG. 1A. As shown in FIGS. 1A and 1B, the liquid crystal device 100 includes a TFT array substrate 10, and a counter substrate 20 joined together by a sealing member 52 provided therebetween. In a space defined by the sealing member 52, a liquid crystal layer 50 is provided and sealed therein. A rectangular area surrounded by a shielding member 53 installed along the inner circumference of the sealing member 52 is a display modulation region 35. A region disposed inside the sealing member 52 but outside the display modulation region 35 is a non-display modulation region 36.

A periphery region outside the sealing member 52 is provided with a data signal driving circuit 101 and external circuit connection terminals 102 arranged along one edge (first edge) off the TFT substrate 10, scan signal driving circuits 104 arranged along two edges (second edge and third edge) adjacent to the first edge of the TFT substrate 10. The scan signal driving circuits 104 are electrically connected to each other via a wiring 105. Inter-substrate connection members 106 are installed at respective corners of the counter substrate 20 in order to electrically connect the TFT substrate 10 to the counter substrate 20.

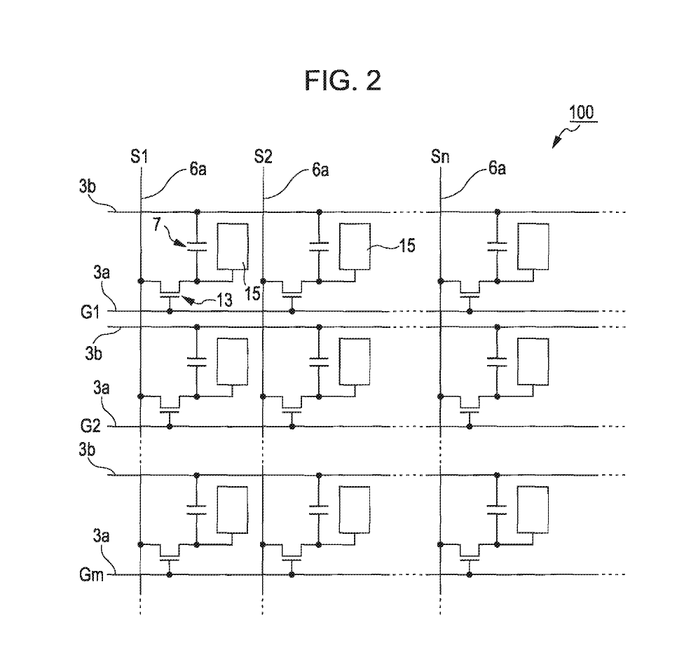

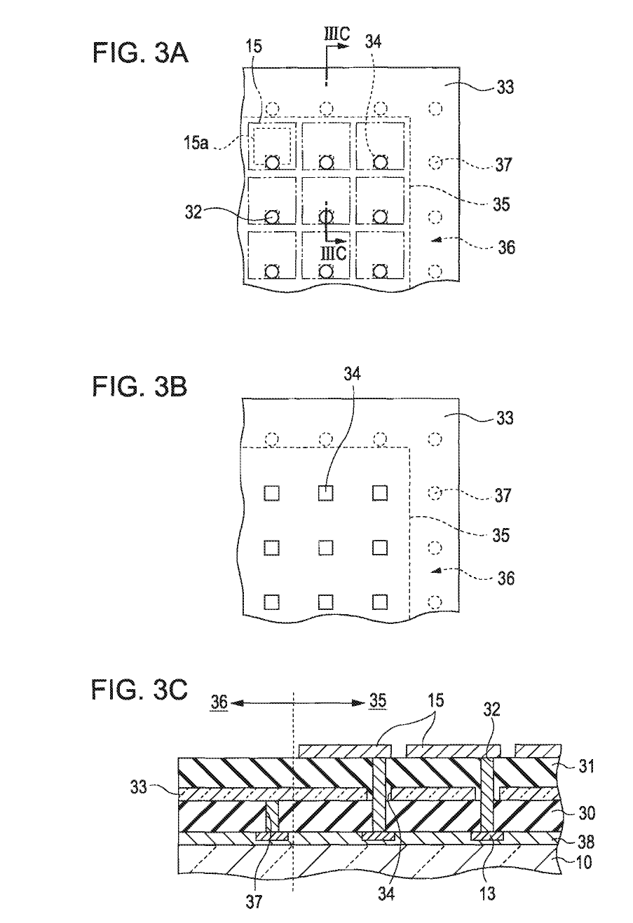

FIG. 2 illustrates an equivalent circuit of the liquid crystal device 100 using TFTS. Data lines 6a and scan lines 3a are arranged to extend over the display modulation region 35 and the non-display modulation region 36 of the TFT array substrate 10 of the liquid crystal device 100 in the form of a matrix, and each portion surrounded by the data lines 6a and the scan lines 3a 's provided with one pixel which is one unit of an image display. Each of a plurality of pixels arranged in the matrix form includes a pixel electrode 15. Practically, since the liquid crystal device includes a light blocking portion (not shown), each pixel 15a is formed in a narrow area (shown in FIG. 3A). This applies to the following embodiments. TFTs 13 serving as switching elements are formed to correspond to the pixels 15a in order to control the corresponding pixel electrodes 15. The data lines 6a are electrically connected to source electrodes of the TFTs 13, and image signals S1, S2, . . . , and Sn are supplied to the TFTs 13 via the data lines 5a. The scan lines 3a are electrically connected to gate electrodes of the TFTs 13 and scan signals G1, G2, . . . , and Gn having a pulse form are supplied to the gate electrodes of the TFTs 13 via the scan lines 3a at predetermined timings. Drain electrodes of the TFTs 13 are electrically connected to the pixel electrodes 15. Accordingly, when the TFTs 13 serving as switching elements are turned on by the scan signals G1, G2, . . . , and Gn supplied via the scan lines 3a and the on-state of the TFTs 13 are maintained for a predetermined periods the image signals S1, S2, . . . and Sn supplied via the data lines 6a are loaded into the corresponding pixels 15a at a predetermined timing.

Predetermined potential levels of the image signals S1, S2, . . . , and Sn loaded into the liquid crystals are maintained by the presence of liquid crystal capacitances provided between the pixel electrodes 15 and a common electrode 25 which will be described below. In order to prevent the image signals S1, S2, . . . , and Sn from leaking, storage capacitances 7 are provided between the pixel electrodes 15 and a capacitance line 3b and are connected to the liquid crystal capacitances in parallel with each other. When a voltage signal is applied to the liquid crystals in the above-mentioned manner, the alignment of the liquid crystals is converted. Thus, light which is incident on the liquid crystals is modulated, and gray-scale can be displayed.

FIGS. 3A to 3C show a structure of an inner surface of the TFT array substrate 10, which faces the counter substrate 20. FIG. 3A is a plan view as viewed from the liquid crystal layer 50. FIG. 3B is a plan view illustrating a structure of an underlayer of the structure shove in FIG. 3B. FIG. 3C is a sectional view taken along line I-I shown in FIG. 3A.

As shown in FIG. 3C, a base layer 38 is formed on the TFT array substrate 10, and the TFTs 13 are formed on the base layer 38. The TFTs 13 are formed so as to correspond to pixels disposed in the display modulation region 35 and the non-display modulation region 36 of the liquid crystal device 100. An insulation layer 30 is formed so as to cover the TFTs 13. An auxiliary electrode 33 is formed on the insulation layer 30. An inter-layer insulation layer 41 is formed on the insulation layer 30 so as to cover the auxiliary electrode 33. The pixel electrodes 15 are formed on the inter-layer insulation layer 31. The pixel electrodes 15 are arranged in the matrix form so as to correspond to the pixels 15a and are connected to drain electrodes of the TFTs 13 through contact holes 32 formed so as to penetrate the inter-layer insulation layer 31 and the insulation layer 30.

The auxiliary electrode 33 is an electrode made of a transparent conductive material, such as Indium Tin Oxide (ITO). The auxiliary electrode 33 is formed over almost the entire surface of the TFT substrate 10 in a plan view. As shown in FIG. 3C, the auxiliary electrode 33 is formed in a layer disposed under the pixel electrodes 15.

As shown in FIGS. 3A and 3B, the auxiliary electrode 33 is electrically connected to the TFTs 13 (drain electrodes) via the contact holes 37 formed so as to penetrate the insulation layer 30 in the non-display modulation region 36. Also, the auxiliary electrode 33 is provided with a plurality of through holes 34. Each through hole 34 is formed so as to surround the corresponding contact hole 32 disposed at a position where the pixel electrode 15 is formed. The auxiliary electrode 33 and the pixel electrode 15 are electrically insulated from each other.

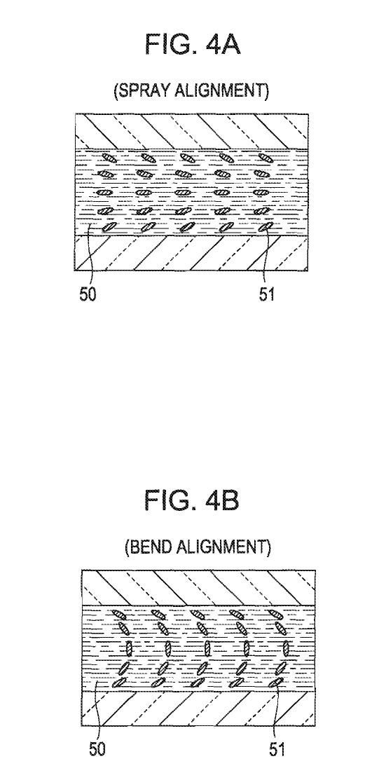

FIG. 4A is a view for explaining an alignment of liquid crystal molecules of an OCB mode liquid crystal device. In the OCB mode liquid crystal device, as shown in FIG. 4A, liquid crystal molecules 51 are arranged in a manner such that they are aligned in a splay form (splay alignment) in an initial state (non-driving period). On the other hand, as shown in FIG. 4B, the liquid crystal molecules 51 are arranged in a manner such that they are aligned in a curve form, such as an arc (bend alignment) in a display operation state (driving period). Thus, light transmittance is controlled by changing the degree of curve of the bend alignment during a driving period, and a fast response in display operation can be achieved.

Hereinafter, a method of manufacturing the liquid crystal device 100 having the above-mentioned structure will be described. First, the base layer 38 is formed on the TFT array substrate 10, and then the TFTs 13 are formed on the base layer 38. After formation of the TFTs 1 the insulation layer is formed on the base layer 38 so as to cover the base layer 38. Then, in the non-display modulation region 36, the contact holes 37 are formed at positions where the drain electrodes of the TFTs 13 are disposed. After formation of the contact holes 37, the auxiliary electrode 33 is formed on the insulation layer 33.

The auxiliary electrode 33 is formed by first forming a conductive thin layer on the entire surface of the insulation layer 30 using, for example, ITO by a sputtering method and then forming through holes 34 at positions overlapping, in a plan view, the drain electrodes of the TFTs 13 disposed in the display modulation region 35. Subsequently, the inter-layer insulation layer 31 is formed on the auxiliary electrode 33.

After formation of the inter-layer insulation layer 31, the contact holes 32 are formed at positions overlapping, in a plan view, the drain electrodes constituting the TFTs 13 in the display modulation region 35 and also overlapping the through holes 34. After formation of the contact holes 32, the pixel electrodes 15 are formed on the inter-layer insulation layer 31 at predetermined positions. After formation of the pixel electrodes 15, an alignment layer (not shown) is formed. Thus, formation of the TFT array substrate 10 is completed.

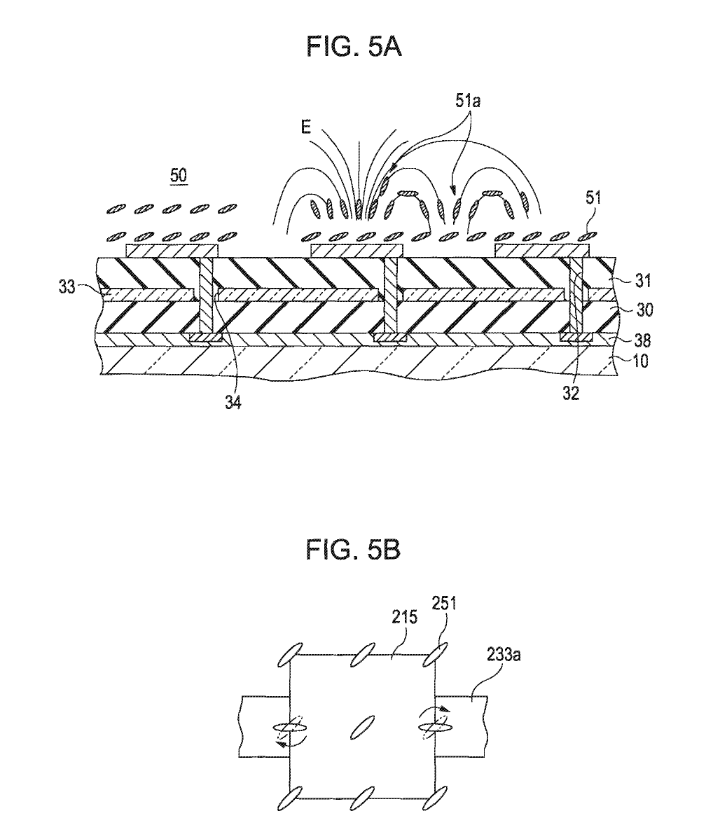

According to this embodiment, the auxiliary electrode 33 is formed so as to cover almost the entire surface of the TFT array substrate 10, while overlapping the pixels 15a. Further, the auxiliary electrode 33 is made of a light-transmissible material, for example ITO. Accordingly, although the auxiliary electrode 33 is formed so as to overlap the pixels 15a in a plan view, the auxiliary electrode 33 does not block light. Moreover, since the auxiliary electrode 33 is formed so as to overlap the pixels 15 in a plan view, as shown in FIG. 5A, it is possible to generate a strong electric field E, so that a maximum potential difference can be created between the pixel electrodes 15 and the auxiliary electrode 33. Thus, it is possible to enhance the efficiency of creation of bend nuclei because the bend nuclei are created by some of the liquid crystal molecules 51 in the liquid crystal layer 50, to which the strong electric field E is perpendicularly applied. For this reason, the bend transition can quickly occur.

Further, since operation of both of the pixel electrodes 15 and the auxiliary electrode 33 are controlled by using the TFTs 13, it is possible to control both of the pixel electrodes 15 and the auxiliary electrode 33 by the use of only a single control system. Accordingly, there is no necessity to separately employ an additional control circuit for the auxiliary electrode 33. That is, a known driving circuit can be used to control the liquid crystal device according to the invention.

### Second Embodiment

Hereinafter, a second embodiment of the invention will be described. In drawings relating to the second embodiment, a scale is arbitrarily determined for showing each element of a liquid crystal device in an enlarged manner so that the elements of the liquid crystal device are readily shown, like the first embodiment. Further, explanation of like elements in the first embodiment and the second embodiment will be omitted. The first embodiment and the second embodiment are different in the structure of the auxiliary electrode. Accordingly, the second embodiment will be described mainly with respect to the structure of the auxiliary electrode.

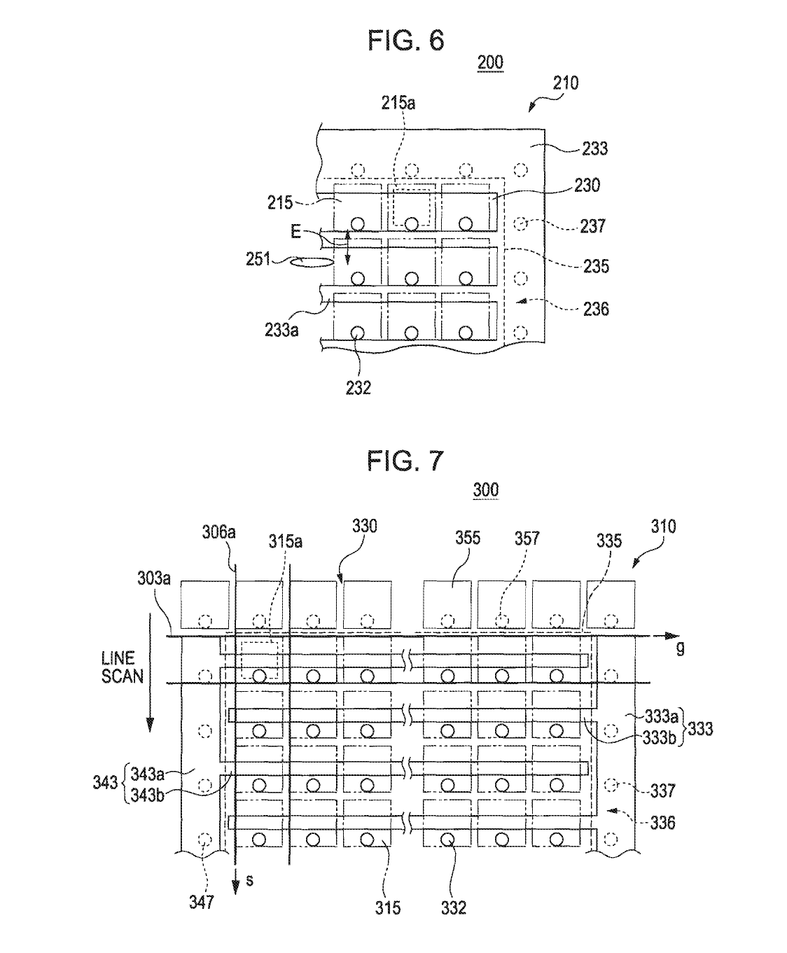

FIG. 6 shows a structure of a TFT array substrate 210 of a liquid crystal device 200 according to the second embodiment, and corresponds to FIG. 3A relating to the first embodiment. The TFT array substrate 210 is provided with a base layer and TFTs as in the first embodiment even though both are not shown. As shown in FIG. 6, an insulation layer 230 is formed so as to cover the TFTs. An auxiliary electrode 233 is formed on the insulation layer 230. An inter-layer insulation layer (not shown) is formed on the insulation layer 230 so as to cover the auxiliary electrode 233. On the inter-layer insulation layer is formed pixel electrodes 215. The pixel electrodes 215 are arranged on the TFT array substrate 210 in the form of a matrix and connected to the TFTs (drain electrodes) through contact holes 232 formed so as to penetrate the inter-layer insulation layer and the insulation layer 230.

The auxiliary electrode 233 is made of a light-transmissible material, such as ITO, as in the first embodiment. The auxiliary electrode 233 is formed over almost the entire surface of a non-display modulation region 236 of the TFT array substrate 210 and electrically connected to the TFTs (drain electrodes) via the contact holes 230 formed so as to penetrate the insulation layer 230. The auxiliary electrode 233 has elongate portions 233a extending to a position disposed within a display modulation region 235.

Each elongate portion 233a extends in a row direction (left-to-right direction in FIG. 6) of the pixel electrodes 215 arranged in the matrix form. Moreover, each elongate portion 233a is disposed between two adjacent rows of the pixel electrodes 215a. Each elongate portion 233a is disposed in a manner such that part thereof overlaps the pixel electrodes 215a in a plan view and an electric field is generated in a direction intersecting an alignment direction of liquid crystal molecules 251 in a liquid crystal layer constituting the liquid crystal device 200, in which the liquid crystal molecules are aligned in the splay form. In this embodiment, for example, the direction of the splay alignment of the liquid crystal molecules 251 is the same as a row direction of the matrix, and a direction of an electric field E generated between the pixel electrodes 251 and the elongate portions 233a of the auxiliary electrode 233 is the same as a column direction of the matrix.

As described above, according to the second embodiment, the elongate portions 233a and the liquid crystal molecules 251 are disposed in a manner such that the direction of the electric field E generated between the elongate portions 233a of the auxiliary electrode 233 and the pixel electrodes 215 intersects the alignment direction of the liquid crystal molecules 251 arranged in the splay alignment. Accordingly, as shown in FIG. 5B, it is possible to twist the liquid crystal molecules 251 toward a direction that a strong electric field E exerts when the strong electric field is generated between the elongate portions 233a of the auxiliary electrode 233 and the pixel electrodes 215. The twisted liquid crystal molecules 251 promote creation of bend nuclei. Accordingly, it is possible to easily create the bend nuclei and thus fast bend transition can be realized.

### Third Embodiment

Hereinafter, a third embodiment of the invention will be described. In drawings relating to the third embodiment, a scale is arbitrarily determined for showing each element of a liquid crystal device in an enlarged manner so that the elements of the liquid crystal device are readily shown, like the first embodiment. Further, explanation about like elements in the first embodiment and the third embodiment will be omitted. The first embodiment and the third embodiment are different in the structure of the auxiliary electrode. Accordingly, the third embodiment will be described mainly with respect to the structure of the auxiliary electrode.

FIG. 7 shows a structure of a TFT array substrate 310 of a liquid crystal device 300 according to the third embodiment, and corresponds to FIG. 3A relating to the first embodiment. The TFT array substrate 310 is provided with a base layer and TFTs like the first embodiment even though both are not shown. As shown in FIG. 7, data lines 306a, scan lines 303a and an insulation layer 330 are formed. Auxiliary electrodes 333 and 343 are formed on the insulation layer 330. On the insulation layer 330, an inter-layer insulation layer (not shown) is formed on the insulation layer 330 so as to cover the auxiliary electrodes 333 and 343. On the inter-layer insulation layer is formed a group of electrodes including pixel electrodes 315 and dummy electrodes 355. The electrodes in the group of electrodes are arranged on the TFT array substrate 310 in the matrix form. Of t group of electrodes, the electrodes disposed in the display modulation region 335 are the pixel electrodes 315, and the electrodes disposed in the non-display modulation region 336 are the dummy electrodes 355. The dummy electrodes 355 are arranged at end portions of the matrix form in a column direction.

The pixel electrodes 315 are connected to the TFTs (drain electrodes) through contact holes 332 formed so as to penetrate the inter-layer insulation layer and the insulation layer 330. The dummy electrodes 355 are connected to the TFTs (drain electrodes) through contact holes 357 formed so as to penetrate the inter-layer insulation layer and the insulation layer 330.

The auxiliary electrodes 333 and 343 are made of, for example, a light-transmissible material, such as ITO as in the first embodiment. The auxiliary electrodes 333 and 343 are formed in a layer disposed under the pixel electrodes 315 and the dummy electrodes 355, the layer being near a surface of the TFT array substrate 310. The auxiliary electrode 333 has a trunk portion 333a disposed at an end portion of the matrix form and extending in a row direction of the pixel electrodes 315 arranged in the matrix form, and the auxiliary electrodes 343 has a trunk portion 343a disposed at the other end portion of the matrix form and extending in the row direction of the pixel electrodes 315 arranged in the matrix form. For example, the trunk portion 333a is disposed at a right side end portion in the drawing and the trunk portion 343a is disposed at a left side end portion in the drawing.

The trunk portion 333a of the auxiliary electrode 333 is connected to the TFTs (drain electrodes) through contact holes 337 formed so as to penetrate the insulation layer 330. The trunk portion 343a of the auxiliary electrode 343 is connected to the TFTs (drain electrodes) through the contact holes 347 formed so as to penetrate the insulation layer 330. The trunk portions 333a and 343a are electrically insulated from each other. The auxiliary electrode 333 has elongate portions 333b extending from the trunk portion 333a toward the trunk portion 343a. The auxiliary electrode 343 has elongate portions 343b extending from the trunk portion 343a toward the trunk portion 333a.

The elongate portions 333b and the elongate portions 343b are disposed in a manner such that each elongate portion 333b or 343b overlaps middle portions of the pixels 315a in a plan view. The elongate portions 333b are connected to the trunk portion 333a and the elongate portions 343b are connected to the trunk portion 343a. The elongate portions 333b and the elongate portions 343b are alternately arranged while corresponding to rows of the pixel's 351a arranged in the matrix form. The elongate portions 333b and the elongate portions 343b are electrically insulated from each other.

To drive the liquid crystal device 300 having the above-mentioned structure, a line potential inversion operation is performed. The line potential inversion operation is performed a row by a row of pixel electrodes 315 in a manner such that alternate rows of the pixel electrodes 315 have the same potential polarities.

According to this embodiment, since the trunk portion 333a and the trunk portion 343a are electrically insulated from each other and the elongate portions 333b and the elongate portions 343b are electrically insulated from each other, it is possible to generate different electric fields between the auxiliary electrode 333 and the pixel electrodes 315 and between the auxiliary electrode 343 and the pixel electrodes 315. According to this embodiment, the liquid crystal device 300 is driven by a method of the line potential inversion operation, the elongate portions 333b extending from the trunk portion 333a and the elongate portions 343b extending from the trunk portion 343a are alternately arranged in a direction (a column direction of the matrix) perpendicular to a direction in which the elongate portions 333b and the elongate portions 343b extend. Accordingly, it is possible to drive the liquid crystal device 300 such that polarities of the strong electric fields generated between the pixel electrodes 315 and the auxiliary electrode 333 and between the pixel electrodes 315 and the auxiliary electrode 343 are the same as those of driving voltages. Thanks to the above driving scheme, it is possible to inhibit disturbance of the alignment of the liquid crystal molecules, which is attributable to the driving voltages. Moreover, it is possible to drive the liquid crystal device so as to maximize intensity of electric fields generated between the pixel electrodes and the auxiliary electrodes. Therefore, creation of bend nuclei accelerates, so that the bend nuclei can be easily created. As a result, fast bend transition can be achieved.

### Fourth Embodiment

Hereinafter, a fourth embodiment will be described. In drawings relating to the fourth embodiment, a scale is arbitrarily determined for showing each element of a liquid crystal device in an enlarged manner so that the elements of the liquid crystal device are readily shown, like the first embodiment. Further, explanation about like elements in the first embodiment and the fourth embodiment will be omitted. The first embodiment and the fourth embodiment are different in the structure of the auxiliary electrode. Accordingly, the fourth embodiment will be described mainly with respect to the structure of the auxiliary electrode.

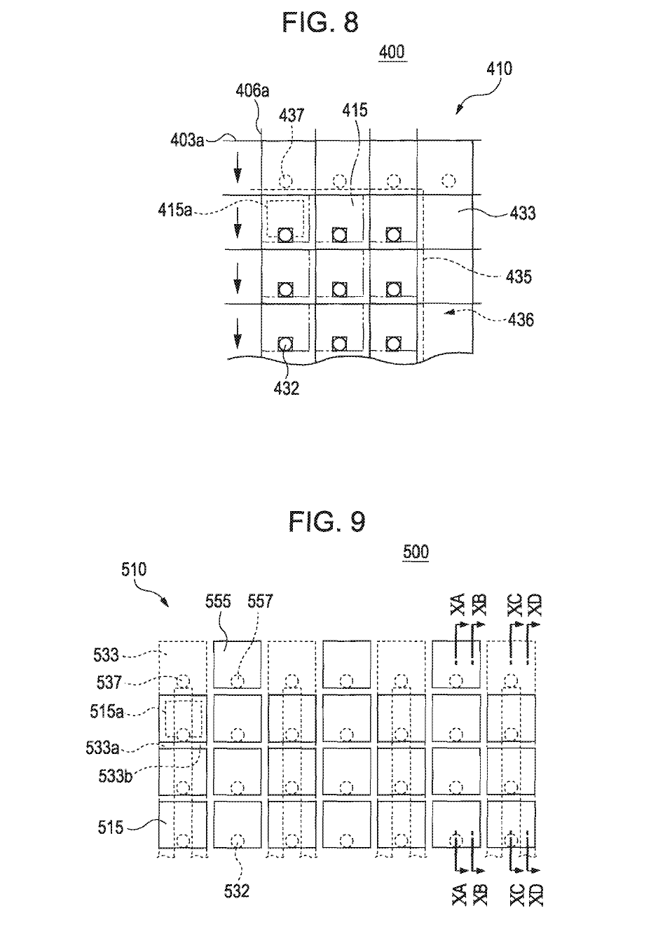

FIG. 8 shows a structure of a TFT array substrate 410 of a liquid crystal device 400 according to the fourth embodiment. FIG. 8 is a plan view illustrating the TFT array substrate 410 of the liquid crystal device 400 and corresponds to FIG. 3A relating to the first embodiment. The TFT array substrate 410 is provided with a base layer, TFTs, and an insulation layer even though none of them are shown in FIG. 8 as in the first embodiment. As shown in FIG. 8, data lines 406a and scan lines 403a are arranged in the form of a matrix. An auxiliary electrode 433 is disposed on the insulation layer 433. An inter-layer insulation layer (not shown) is formed on the insulation layer 433 so as to cover the auxiliary electrode 433. Pixel electrodes 415 are formed on the inter-layer insulation layer. The pixel electrodes 415 are disposed in a display modulation region of the TFT array substrate 410 in the form of a matrix. The pixel electrodes 415 are connected to the TFTs (drain electrodes) through contact holes 432 formed so as to penetrate the inter-layer insulation layer and the insulation layer.

The auxiliary electrode 433 is made of, for example a light-transmissible material, such as ITO as in the first embodiment. The auxiliary electrode 433 is formed over almost the entire surface of the TFT array substrate 410 so as to overlap pixels 415a in a plan view. The auxiliary electrode 433 is disposed in a layer disposed under the pixel electrodes 415.

The auxiliary electrode 433 is electrically connected to the TFTs (drain electrodes) disposed along one line of the scan lines 403a through contact holes 437 formed so as to penetrate the insulation layer, in a non-display modulation region 436. Through holes 434 are formed in a manner of surrounding the corresponding contact holes 432 disposed in the pixel electrodes 415 in a display modulation region 435, and the auxiliary electrode 434 and the pixel electrodes 415 are electrically insulated from each other.

The liquid crystal device 400 is driven in a manner such that writing operations are performed one scan line by one scan line 403a, that is, one row by one row in the pixel electrodes 415, the row corresponding to the scan line. That is, after writing to one line of the scan lines 403a is finished, writing to the pixel electrodes 415 is performed one row by one row in a column direction of the pixel electrode matrix (a down arrow direction of FIG. 8).

According to this embodiment, the auxiliary electrode 433 is connected to the TFTs disposed along one line of the scan line 403a of the data lines 406a. Accordingly, a strong electric field is generated between the pixel electrodes 415 and the auxiliary electrode 433 during a driving period in which only the one scan line 403a is driven. For this reason, the liquid crystal device 400 has an advantage in that it is difficult for the strong electric field to influence the display operation and the optical modulation operation during the driving period of the liquid crystal device 400, so that a display having excellent characteristic can be obtained.

### Fifth Embodiment

Hereinafter, a fifth embodiment will be described. In drawings relating to the third embodiment, a scale is arbitrarily determined for showing each element of a liquid crystal device in an enlarged manner so that the elements of the liquid crystal device are readily shown, like the first embodiment. Further, explanation about like elements in the first embodiment and the fifth embodiment will be omitted. The first embodiment and the fifth embodiment are different in the structure of an auxiliary electrode. Accordingly, the fifth embodiment will be described mainly with respect to the structure of the auxiliary electrode.

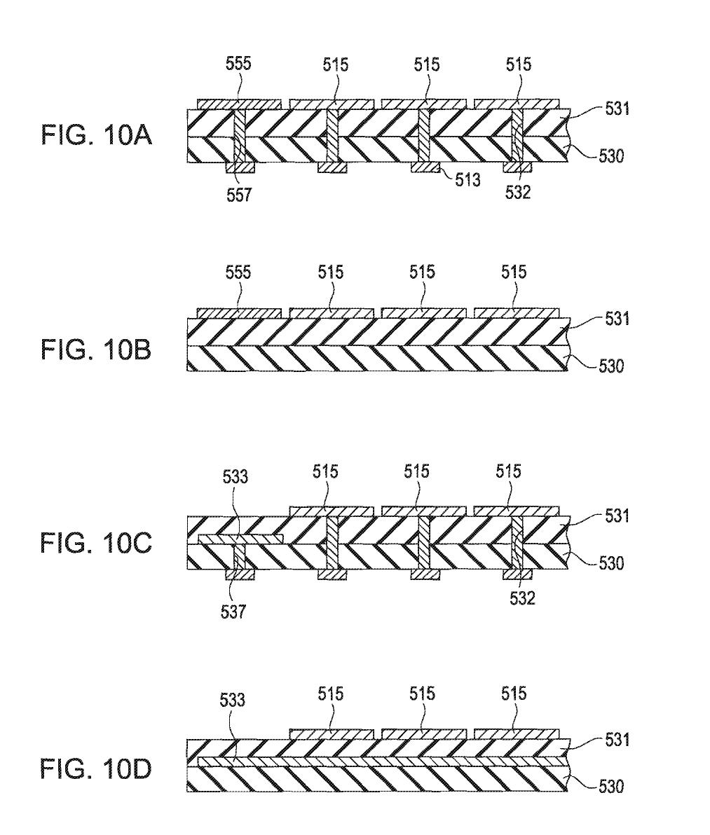

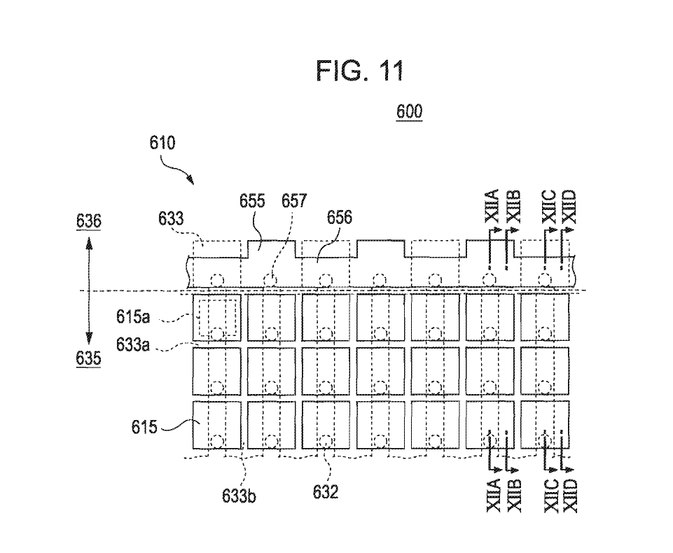

FIG. 9 shows a structure of a TFT array substrate 510 of a liquid crystal device 500 and corresponds to FIG. 3A relating to the first embodiment. FIG. 10A is a sectional view taken along line A-A shown in FIG. 9, FIG. 10B is a sectional view taken along line 313 shove in FIG. 9, FIG. 10C is a sectional view taken along line C-C shown in FIG. 9, and FIG. 10D is a sectional view taken along line D-D shown in FIG. 9.

According to this embodiment, pixel electrodes 515 are arranged in the form of a matrix. The pixel electrodes 515 are grouped into first columns having the pixel electrodes 515 overlapping the auxiliary electrode 533 in a plan view and second columns having dummy electrodes, in which the first columns and the second columns are alternately arranged.

The sectional structure of the liquid crystal device will be described with reference to FIGS. 10A to 10D. The TFT array substrate 510 is provided with a base layer, TFTs 513 and an insulation layer 533 as in the first embodiment. An auxiliary electrode 533 is disposed on the insulation layer 530 (FIG. 10C). An inter-layer insulation layer 531 is formed on the insulation layer 530 so as to cover the auxiliary electrode 533. Pixel electrodes 515 and dummy electrodes 555 are formed on the inter-layer insulation layer 531 (FIGS. 10A and 10B). The pixel electrodes 515 are connected to the TFTs (drain electrodes) through contact holes 532 disposed so as to penetrate the inter-layer insulation layer 531 and the insulation layer 530. The dummy electrodes 555 are formed in the same layer as the pixel electrodes 515 and connected to the TFTs (drain electrodes) through the contact holes 532 formed so as to penetrate the inter-layer insulation layer 531 and the insulation layer 530 (FIG. 10C).

The plan structure of the liquid crystal device will be described below. As shown in FIGS. 10A to 10D, the pixel electrodes 515 are disposed in the matrix form in a display modulation region 535 of the TFT array substrate 510. The auxiliary electrode 533 is disposed at positions corresponding to alternate columns of the pixel electrodes 515, skipping one column of the pixel electrodes 515 in a manner of overlapping the pixel electrodes 515 in a plan view. The dummy electrodes 555 are disposed at the columns in which the auxiliary electrode 533 is not disposed, in a non-display modulation region 536.

According to this embodiment, the pixel electrodes 515 are grouped into a plurality of columns, including first columns in which the auxiliary electrode 533 overlaps pixels 515a in a plan view and second columns in which dummy electrodes 555 are disposed. The first columns and the second columns are alternately arranged. Accordingly, electrodes (dummy electrodes 555) used in the dummy pixels and the auxiliary electrode 533 having different functions from each other can be separately provided in the liquid crystal device.

### Sixth Embodiment

Hereinafter, a sixth embodiment will be described. In drawings relating to the sixth embodiment, a scale is arbitrarily determined for showing each element of a liquid crystal device in an enlarged manner so that the elements of the liquid crystal device are readily shown, like the first embodiment. Further, explanation about like elements in, the first embodiment and the sixth embodiment will be omitted. The first embodiment and the sixth embodiment are different in the structure of an auxiliary electrode. Accordingly, the sixth embodiment will be described mainly with respect to the structure of the auxiliary electrode.

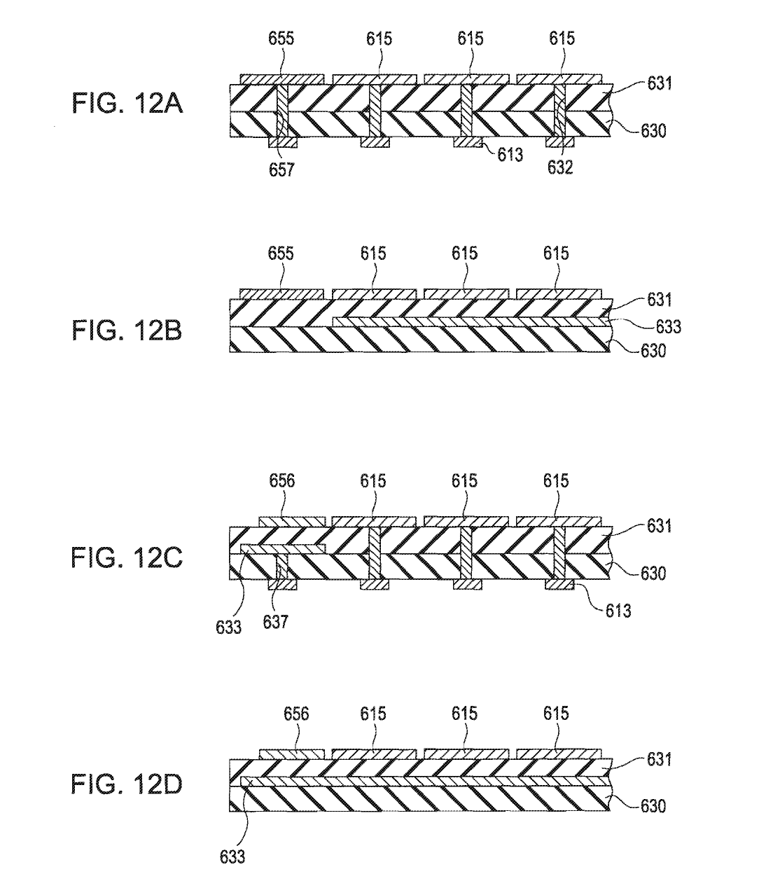

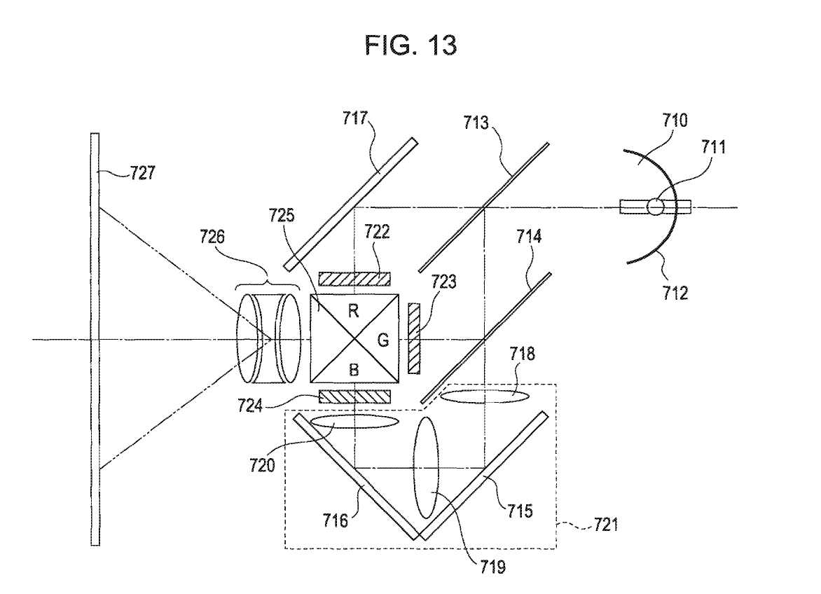

FIG. 11 illustrates a plan structure of a TFT array substrate 610 of a liquid crystal device 600 according to the sixth embodiment and corresponds to FIG. 3A relating to the first embodiment. FIGS. 12A, 12B, 12C and 12D shows the sectional structures taken along lines A-A, B-B, C-C, and D-D, respectively shown in FIG. 11.

According to this embodiment, pixel electrodes 615 are arranged in the matrix form, and the auxiliary electrode 633 and dummy electrodes 655 are disposed in three dimensions. The section structure of the liquid crystal device will be described with reference to FIGS. 12A to 12D. A TFT array substrate 610 is provided with a base layer, TFTs 613, and an insulation layer 630 as in the first embodiment. An auxiliary electrode 633 is disposed on the insulation layer 630. An inter-layer insulation layer 631 is formed on the insulation 630 so as to cover the auxiliary electrode 633 (FIG. 12C). Pixel electrodes 615 and dummy electrodes 655 are formed on the inter-layer insulation layer (FIGS. 12A and 12B). The pixel electrodes 615 are connected to the TFTs (drain electrodes) via contact holes 631 formed so as to penetrate the inter-layer insulation layer 631 and the insulation layer 630. The dummy electrodes 655 are formed in the same layer as the pixel electrodes 615, and connected to the TFTs (drain electrodes) via the contact holes 657 formed so as to penetrate the inter-layer insulation layer 631 and the insulation layer 630 (FIG. 12A).

Next, the plan structure of the liquid crystal device 600 will be described with reference to FIG. 11. As shown in FIG. 11, the pixel electrodes 615 are disposed in a display modulation region 635 of the TFT array substrate 610 in the matrix form. The auxiliary electrode 633 is disposed at positions corresponding to alternate columns of the pixel, electrodes 615, skipping one column of the pixel electrodes 615, in a non-display modulation region 636, and disposed so as to overlap two adjacent columns of pixels 615a within a display modulation region 635 in a plan view. The auxiliary electrode 633 is formed so as to open middle portions of the pixels 615a within the display modulation region 635.

The dummy electrodes 655 are disposed so as to extend in a row direction in the non-display modulation region 636. In the columns in which the auxiliary electrode 633 is not disposed in the matrix of the pixel electrodes 615, the size of each dummy electrode 655 in a column direction is almost the same as the size of each pixel electrode 615 in the column direction. The contact holes 657 are formed at positions where the dummy electrodes 655 are disposed in the non-display modulation region 636. Each dummy electrode 655 in the columns in which the auxiliary electrode 633 is disposed has a constricted portion 656 constricted in a column direction, and the constricted portions 656 of the dummy electrodes 655 overlap the auxiliary electrode 633 in a plan view.

According to this embodiment, the dummy electrodes 655 are formed in the same layer as the pixel electrodes 615 such that they overlap at least part of the auxiliary electrode 633 in a plan view. Accordingly, the auxiliary electrode 633 is formed in a layer disposed under the dummy electrodes 633 and thus the dummy electrodes 655 and the auxiliary electrode 633 are arranged in three dimensions. Thanks to this structure, the electrodes serving as dummy pixels employed in the knoll liquid crystal device and the electrode serving as the auxiliary electrode having different functions from each other can be separately provided.

### Seventh Embodiment

Hereinafter, a structure of a projection display device (projector) having the above-mentioned liquid crystal device as an optical modulation unit will be described with reference to FIG. 13. FIG. 13 shows main part of the projection display device 700 employing the above-mentioned liquid crystal device as an optical modulation unit. In FIG. 13, a reference numeral 710 denotes a light source, reference numerals 713 and 714 denote dichroic mirrors, reference numerals 715, 716, and 717 denote reflective mirrors, a reference numeral 718 denotes an incidence lens, a reference numeral 719 denotes a relay lens, a reference numeral 720 denotes an emission lens, reference numerals 722, 723 and 724 denote liquid crystal modulation devices, a reference numeral 725 denotes a crossdiachroic prism and a reference numeral 726 denotes a projection lens.

The light source 710 is composed of a metal halide lamp 71 or the like, and a reflector 712 reflecting light emitted from the lamp. The dichroic mirror 713 for reflecting blue light and green light allows red light of a beam of light emitted from the light source 710 to penetrate therethrough but reflects blue light and green light therefrom. The transmitted red light is reflected on the reflective mirror 717 and impinges to a red color liquid crystal light modulation device 722 having the liquid crystal device according to any of the embodiments of the invention.

On the other hand, the green light of color lights reflected from the dichroic mirror 713 is reflected again from the dichroic mirror 714 provided in order to reflect green light and is incident on a green light liquid crystal optical modulation device 723 having the liquid crystal device according to any one of the embodiments above. Further, the blue light penetrates even a second dichroic mirror 714. For modulation of blue light, an optical guide unit 721 composed of a relay lens system including the incident lens 718, the relay lens 719 and the emission lens 720 is provided so as to compensate the blue light having a optical path length different from that of green light and red light. The blue light is incident on a blue light liquid crystal optical modulation device 724 employing the liquid crystal device according to any one of the embodiments above via the optical guide unit 721.

Three colors of light modulated by the corresponding optical modulation devices are incident on the crossdichroic prism 725. The prism is composed of four right angle prisms joined together, a dielectric multi-layered structure for reflecting blue light and a dielectric multi-layered structure for reflecting red light, the dielectric multi-layered structures being arranged in the cross form on the inner surfaces of the prism. Thanks to the dielectric multi-layered structures, three colors of light are synthesized together, and light displaying a color image is formed. The synthesized light is projected on a screen 727 by a projection lens 726 serving as a projection optical system and thus an image is enlarged and displayed. According to this embodiment, since the projector includes the liquid crystal device which is capable of effectively carrying out fast bend transition, the projector 700 can performs a display having excellent display characteristics at fast response speed.

### Eighth Embodiment

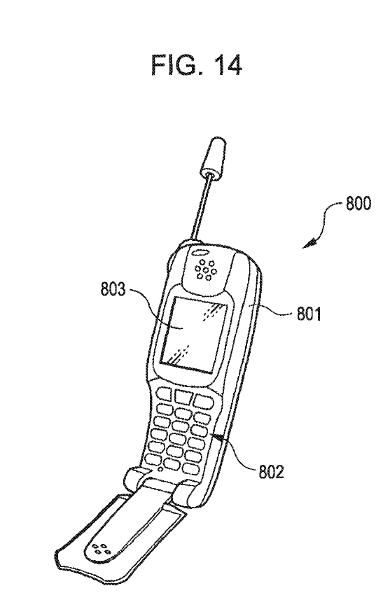

Hereinafter, an eighth embodiment will be described. This embodiment relates to a mobile phone. FIG. 14 shows an overall structure of a mobile phone 800 in a perspective manner. The mobile phone 800 is mainly composed of a housing 801, a manipulation portion 802 in which a plurality of manipulation buttons is disposed, and a display portion displaying still pictures, moving images and characters. The display portion 803 employs a liquid crystal display device in which the liquid crystal device according to any of the embodiments above is combined with a color filter.

According to this embodiment, the liquid crystal device being capable of effectively carrying out fast bend transit ion is mounted, it is possible to realize an electronic apparatus having a display portion excellent in display characteristics and fast in response speed.

Application of the liquid crystal device according to the embodiments is not limited to the mobile phone, but the liquid crystal device according to the embodiments may be adequately applied to an image display device of electronic apparatuses provided with an electronic book, a personal computer, a digital still camera, a liquid crystal TV, a viewfinder type or a monitor type video recorder, a car navigation device, a pager, an electronic organizer, a calculator, a word processor, a workstation, a television phone, a POS terminal, or a touch panel.

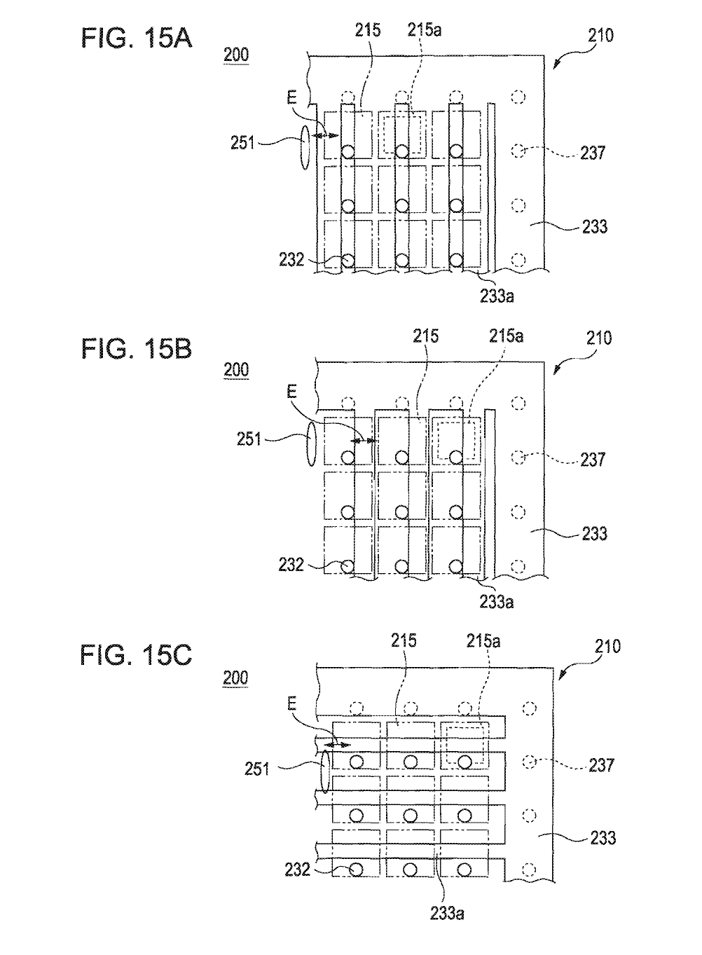

The scope of the invention is not limited to the above embodiments but includes modifications as long as the modification are not apart from the spirit of the invention. For example, it is exemplified that the elongate portions 233a of the auxiliary electrode 233, extend in the left-to-right direction in the drawing (the row direction of the matrix form) in the second embodiment, but those may extend in the up-to-down direction in the drawing (the column direction of the matrix form) as shown in FIGS. 15A and 15B.

In this case, as shown in FIG. 15A, a middle portion, in a row direction, of each pixel 215a is open and both edge portions, in the row direction, of each pixel 215 overlap the elongate portion 233a of the auxiliary electrode 233 in a plan view. Alternatively, only one edge portion of each pixel 315a in the row direction may overlap the elongate portion 233a in a plan view, as shown in FIG. 15B. As shown in FIG. 15C, in the case in which the elongate portion 233a extends in the left-to-right direction in the drawing, a middle portion, in a column direction, of each pixel 215 may overlap the elongate portion 233a of the auxiliary electrode 233 in a plan view. In any of the cases, it is desirable that the auxiliary electrode 233 is disposed such that the direction of the electric field generated between the auxiliary electrode 233 and the pixel electrodes 215 intersects the alignment direction of the liquid crystal molecules 251 arranged in the splay alignment.

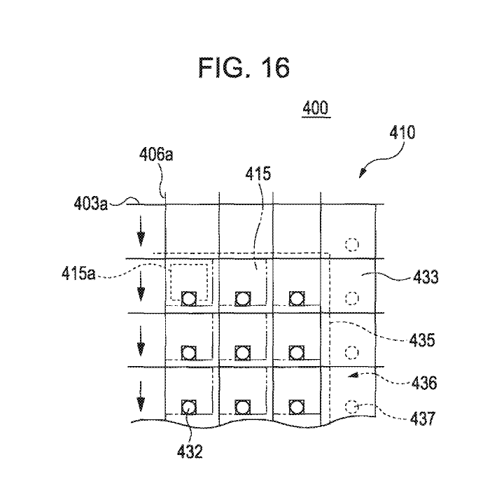

In the fourth embodiment, it is exemplified that the auxillary electrode 433 within the non-display modulation region 436 is electrically connected to the TFTs (drain electrodes) disposed along one line of the scan lines 403a but the structure of the auxiliary electrode 433 is not limited to the example. For example, as shown in FIG. 16, the auxiliary electrode 433 within the non-display modulation region 436 may be electrically connected to the TFTs disposed along one line of the data lines 406a. In this case, since a song electric field is generated between the auxiliary electrode 433 and the pixel electrodes 415 every when one line by one line of the scan lines 404 is scanned, efficiency of creation of bend nuclei is enhanced at the time of performing the bend transition. Moreover, the bend alignment can be easily maintained during the display operation.

The entire disclosure of Japanese Patent Application No. 2006-269918, filed Sep. 29, 2006 is expressly incorporated by reference herein.

What is claimed is:

1. A liquid crystal device performing a display operation or an optical modulation operation by converting an alignment of liquid crystal molecules from a splay alignment to a bend alignment, the liquid crystal device comprising:
a first substrate and a second substrate in opposition with each other;
a liquid crystal layer interposed between the first substrate and the second substrate, the liquid crystal layer including liquid crystal molecules convertible from a splay alignment to a bend alignment;
a plurality of pixel electrodes disposed between the liquid crystal layer and the first substrate;
a common electrode disposed between the liquid crystal layer and the second substrate; and
an auxiliary electrode disposed between the first substrate and the plurality of pixel electrodes, the auxiliary electrode at least partially overlapping each of the pixel electrodes in plan view and being made of a light-transmissible conductive material.

2. The liquid crystal device according to claim 1, wherein the auxiliary electrode is formed so as to cover almost the entire surface of the substrate.

3. The liquid crystal device according to claim 2, wherein the pixel electrodes are arranged in a first region of the substrate in a matrix form, switching elements allowing or not allowing driving signals to transmit are arranged in the first region and a second region arranged outside the first region in a matrix form, data lines and scan lines which supply the driving signals to the switching elements are arranged in a matrix form, and the auxiliary electrode is connected to the switching elements disposed along any one line of the data lines and scan lines.

4. The liquid crystal device according to claim 1, wherein a direction of an electric field generated between the auxiliary electrode and the pixel electrodes intersects an alignment direction of the liquid crystal molecules arranged in the splay alignment.

5. The liquid crystal device according to claim 1, wherein a number of the pixel electrodes is plural, a number of wirings which supply an electric signal to the plural pixel electrodes is plural, one wiring by one wiring of the plural wirings supplies a single to the pixel electrodes, the auxiliary electrode includes a first auxiliary electrode cooperating with some pixel electrodes to generate a first electric field and a second auxiliary electrode cooperating with some pixel electrodes electrically insulated from the first auxiliary electrode to generate a second electric field different from the first electric field, and the first auxiliary electrode and the second auxiliary electrode are alternately arranged along the corresponding wirings.

6. The liquid crystal device according to claim 1, wherein the pixel electrodes are arranged in a plurality of columns including first columns in which the auxiliary electrode overlaps the pixels in a plan view and second columns in which dummy electrodes are provided, and the first columns and the second columns are alternately arranged.

7. The liquid crystal device according to claim 1, wherein a dummy electrode is provided in the same layer as the pixel electrode in a manner of overlapping at least part of the auxiliary electrode in a plan view.
